(19) United States
(12) Patent Application Publication
(10) Pub. No.: US 2026/0356185 A1
(43) Pub. Date: Nov. 12, 2026

(54) VEHICLE

(71) Applicant: Liebherr Mining Equipment Newport News Co., Newport News, VA (US)

(72) Inventor: James WHITFIELD, Jr., Newport News, VA (US)

(21) Appl. No.: 19/203,884

(22) Filed: May 9, 2025

(51) Int. Cl. B60K 7/00; B60P 1/04

(52) U.S. Cl. CPC B60K 7/0007; B60P 1/04

(57) ABSTRACT

The present application provides a vehicle, comprising a frame, wheels arranged on the frame, at least one electrical traction motor for driving the vehicle, and an installation space for an exchangeable power unit, the vehicle being configured such that the exchangeable power unit provides, when installed in the installation space, electrical energy to the at least one electrical traction motor. According to the present disclosure, the frame comprises a saddle mount and the installation space comprises a first sub-space for receiving a first sub-unit of the power unit and a second sub-space for receiving a second sub-unit of the power unit, the first and the second sub-space being interconnected by a connection space. The first and the second sub-space are arranged on lateral outer sides of the saddle mount and the connection space extends from the first sub-space over the saddle mount to the second sub-space.

### TECHNICAL FIELD

The present disclosure relates to a vehicle, in particular to a dump truck.

### BACKGROUND

In order to provide zero emissions vehicles, in particular zero emission haul trucks, one technology is the use of batteries as the prime energy source. The limitations with present battery solutions includes charging solutions. Static charging requires additional machines to make up for the charging time. Decreasing the charging time requires higher charge rates, special cooling, and can impact battery life. Dynamic charging is an alternative, but is complex and requires additional fixed infrastructure such as trolley lines that increase costs.

WO 2019/168888 A1 shows a dump truck having a replaceable battery assembly and an auxiliary, fixed battery pack. When the primary battery is exchanged, the mounting system on the truck is operated by the auxiliary battery, and the truck is powered by the auxiliary battery to be driven to another place to take up a new battery.

EP 4 371 809 A1 shows a dump truck having a primary, non-replaceable battery and a secondary, replaceable battery.

US 2007/0228803 A1 shows a three-wheel concept for a conventionally powered dump truck with floating tires.

CN 118753022 A provides a mechanism to raise an exchangeable battery arranged on a front side of the dump truck.

U.S. Pat. No. 11,541,739 B2 shows an electric haul truck where an exchangeable primary battery is mounted at one side of the cabin on the front of the truck. The truck has levers for taking up the battery from the ground.

### SUMMARY

On object of the present disclosure is to provide an improved concept for arranging an exchangeable power unit comprising a battery on the vehicle.

In a first general aspect, the present disclosure provides a vehicle, comprising a frame, wheels arranged on the frame, at least one electrical traction motor for driving the vehicle, and an installation space for an exchangeable power unit, the vehicle being configured such that the exchangeable power unit provides, when installed in the installation space, electrical energy to the at least one electrical traction motor. According to the present disclosure, the frame comprises a saddle mount and the installation space comprises a first sub-space for receiving a first sub-unit of the power unit and a second sub-space for receiving a second sub-unit of the power unit, the first and the second sub-space being interconnected by a connection space. The first and the second sub-space are arranged on lateral outer sides of the saddle mount and the connection space extends from the first sub-space over the saddle mount to the second sub-space and is configured to receive a cross member of the exchangeable power unit connecting the first sub-unit and the second sub-unit such that the cross member is supported by the saddle mount when the exchangeable power unit is mounted on the frame.

In a second general aspect, the present disclosure provides a vehicle comprising a frame, wheels arranged on the frame, at least one electrical traction motor for driving the vehicle, an axle on which at least one of the wheels is mounted, and an installation space for an exchangeable power unit, the vehicle being configured such that the exchangeable power unit provides, when installed in the installation space, electrical energy to the at least one electrical traction motor. According to the disclosure, the installation space comprises a first sub-space and a second sub-space arranged on lateral outer sides of the axle, the first sub-space and a second sub-space being configured for receiving a first sub-unit and a second sub-unit of the exchangeable power unit, respectively.

The first and the second general aspect may be combined.

The present disclosure further comprises an exchangeable power unit for a vehicle, the ex-changeable power unit comprising a first sub-unit and a second sub-unit connected by a cross member, the cross member configured to support the weight of the first sub-unit and the second sub-unit.

The present disclosure further comprises a system for operating a plurality of vehicles according to the first and/or the second general aspect, and at least one power unit exchange station for exchanging the exchangeable power unit, the power unit exchange station comprising at least one actuator for horizontally and/or vertically removing the exchangeable power unit from the vehicle.

The present disclosure further comprises a method for operating a plurality of vehicles according to the first and/or the second general aspect, the method comprising
operating the plurality of vehicles to perform missions, and
when a charge state of a first exchangeable power unit used for operating one of the vehicles is below a threshold, exchanging the first exchangeable power unit with a fully loaded second exchangeable power unit and statically loading the first exchangeable power unit while it is dismounted from the vehicles.

The present disclosure provides a new vehicle concept that facilitates quick exchange of the power unit. With a novel frame design and reconfiguration of the primary elements of the vehicle, the power unit may be positioned in a manner that supports quick vertical, horizontal, or combination thereof removal of the unit.

If the power unit is a battery electric power unit, the quick exchange feature allows multiple spare power units to be charged in parallel to operation of the vehicles at the most efficient charge rates. It may also support variable sized power units that allow the vehicle to receive the optimal sized power unit based on its application/operational assignment which may change frequently.

The present disclosure provides a novel frame or chassis design that supports a quick exchange of the power units, such as battery modules used for powering the vehicle.

The quick exchange of the exchangeable power unit acting as a primary battery module for operating the vehicle avoids static charging delays. The exchange may require less than five minutes. The exchange may be in a vertical or a horizontal direction.

The power units may be sized and tailored to the specific application of the vehicle, and in particular be provided in different types having a different storage capacity.

In other embodiments, the power unit may be a fuel cell power unit, and may comprise a fuel cell and optionally a battery, it may be an alternate fuel such as hydrogen, ammonia, methanol and/or diesel internal combustion engine power unit, and may in particular comprise a first and a second internal combustion engine, and may be a hybrid power unit comprising an internal combustion engine in combination with a battery unit, the internal combustion engine being e.g. an alternate fuel such as hydrogen, ammonia, methanol and/or diesel internal combustion engine.

One advantage for these variants may be an increased fuel storage volume (in particular it is required for Hydrogen).

Further, the new concept provides an ability for quick powertrain exchange, which has advantages in particular for complex powertrain variants. In particular, the power unit can be reconditioned in a workshop and exchanged quickly to offset downtime that the complexity might bring.

Further, the vehicle could support changing power units and in particular powertrain types over its lifespan. Downtime associated with powertrain reliability is also reduced.

The vehicle of the present disclosure therefore provides an electrified chassis that supports multiple power units and therefore multiple powertrain technologies. By simply connecting an exchangeable power unit to the vehicle, the vehicle is ready to move. Therefore, one could install any variant of the power unit on the vehicle and achieve dump truck functionality.

Embodiments of the concept allow for a near-zero turning radius and/or bi-directional travel.

Embodiments may provide a fixed secondary battery module for powering the vehicle for example during maintenance when the exchangeable power unit is removed.

The fixed secondary battery modules may in particular allow for maintenance travel of the vehicle.

In an embodiment, a steerable front axle can rotate between the subunits of the power unit with a centrally arranged steering axle for near-zero turn.

A cross member, in particular configured as a truss structure, may be configured to connect the power unit with the frame with a quick connection mechanism.

The cross member may extend laterally to connect the first and the second subunit of the exchangeable power unit arranged on opposite lateral outer sides of the vehicle and in particular on opposite sides of the axle.

The rear axle may be provided as a fixed axle on the frame structure. Conventional traction motors with integrated gears may be provided for driving the rear axle.

The exchangeable power unit may be saddled over a saddle mount of the frame for easy access.

A conventional inverter cabinet may be provided on the frame.

One or more battery exchange stations may be provided on the site for exchanging the exchangeable power units. The power units may therefore be exchanged quickly with a fully charged and/or conditioned power unit. This avoids delays from static charging and/or conditioning. Further, the charging of the power units can be done at an optimal rate for better battery life and/or the conditioning can be done in the workshop. Further, modules can have different sizes and can be exchanged based on upcoming assignments within the mine.

The front axle used for steering may not be powered, but provided as a caster axle. Steering may be effected by a hydraulic or electric motor. The steering axle may be powered with a rack/pinion/slew bearing. The axle may be configured to turn +/−90° from center axis. No steering cylinders are required for this configuration.

Propulsion can be provided with standard traction motors and gears. A grid box may be positioned on a lateral side of the frame between the rear axle and the exchangeable power unit, or an inverter cabinet arranged on top of the frame.

The secondary battery unit fixed on the frame may provide minimal energy capacity to allow the vehicle to operate for maintenance, such as tire change. It may be charged from the exchangeable power unit, and provides power during exchange of the exchangeable power unit. The cooling of the fixed battery module may be from the exchangeable power unit or independently of the exchangeable power unit.

The frame may be a three-wheel or a three-axle concept that minimizes torsion requirements. The axle structure may be integrated into the frame, i.e. no rear suspension may be provided.

The novel concept, including its optional features, may provide a number of advantages:

The disclosure may provide a vehicle and in particular haul truck concept that facilitates quick (e.g. 3-5 minute) exchange of battery modules and additional features. With a novel chassis design and reconfiguration of the primary elements of an electric vehicle such as a haul truck, the power unit are positioned in a manner that supports quick vertical, horizontal, or combination thereof removal of the power unit.

The exchange of the power unit can e.g. be performed with crane variants (e.g. RTG, rail crane, fixed crane) or with a ground based skid/conveyor support system to exchange the module. The latter may involve a special lifting feature of the chassis with the suspension.

The quick exchange feature may allow multiple spare power units to be charged in parallel to operation of the machine at the most efficient charge rates. It may also support variable sized power units that allow the haul truck to receive the optimal sized power unit based on its application/operational assignment, which may change frequently. The concept may be designed to be fully automated without an operator cab.

The concept may be designed to provide near zero turning radius with a pair of steerable wheels that can rotate +−90 degrees. The concept may be designed for bi-directional travel, achieving travel speeds with steering wheels fore or aft. Both of these features can increase cycle time of the haul truck. The zero turning nature of the concept can reduce space requirements for loading and dumping areas. The bi-directional travel aspect of the concept can improve cycle time by removal of the cusp maneuver required by conventional haul trucks in loading and dumping.

The quick exchange is an alternate to existing static charging methods (time consuming) or dynamic charging methods (e.g. trolley infrastructure). The present disclosure may therefore solve the problem of excessive charge time for static charging options and/or reduce the need for high charge rates. To maintain production, additional vehicles must be utilized to cover the down time associated with static charging and the present disclosure can eliminate the need for additional haul trucks.

The present disclosure may further solve the problem of complex infrastructure for dynamic charging options such as trolley or flexible trolley solutions. Multiple spare power units can be charged at the most efficient charge rate and quickly cycled in and out of the vehicles. The infrastructure to support this concept is minimal compared to dynamic charging infrastructures. Also, the infrastructure can be placed at opportune locations within the mine whereas dynamic charging is generally widespread through the mine and may often be required on ramps.

The concept supports a lightweight chassis design which can offer additional payload for a given tire size.

The concept supports fleet optimization. It allows vehicles to be equipped with the optimal energy storage instead of a fixed capacity energy storage. With the quick exchange feature, variable size battery modules/power units can be exchanged. So haul trucks can carry the optimal sized battery module/power unit and not more. Fleet management systems can assign the appropriate module size based on the haul/application that the truck will be assigned to.

The concept may be designed to be fully automated without an operator cab.

### BRIEF DESCRIPTION OF THE DRAWINGS

The present disclosure will now be described in more details on the basis of the following embodiments and drawings, in which the following is shown:

FIG. 1 a perspective view of an embodiment of a vehicle and an exchangeable power unit according to the present disclosure,

FIG. 2 a further perspective view of the vehicle and exchangeable power unit shown in FIG. 1,

FIG. 3 a perspective view of the embodiment of the vehicle shown in FIGS. 1 and 2, with the exchangeable power unit removed,

FIG. 4 a further perspective view of the vehicle shown in FIG. 3 with the exchangeable power unit removed,

FIG. 5 a perspective view of the embodiment of the exchangeable power unit,

FIG. 6 a schematic plan view of the embodiments shown in FIG. 1-5,

FIG. 7 an embodiment of a system comprising a vehicle and a first embodiment of a battery exchange station,

FIG. 8 an embodiment of a system comprising a vehicle and a second embodiment of a battery exchange station,

FIG. 9 a perspective view of the embodiment of the vehicle shown in FIGS. 1 to 6 combined with a second embodiment of an exchangeable power unit,

FIG. 10 a further perspective view of the combination shown in FIG. 9, and

FIG. 11 an embodiment of a system for operating a plurality of vehicles comprising a centralized platform.

### DETAILED DESCRIPTION

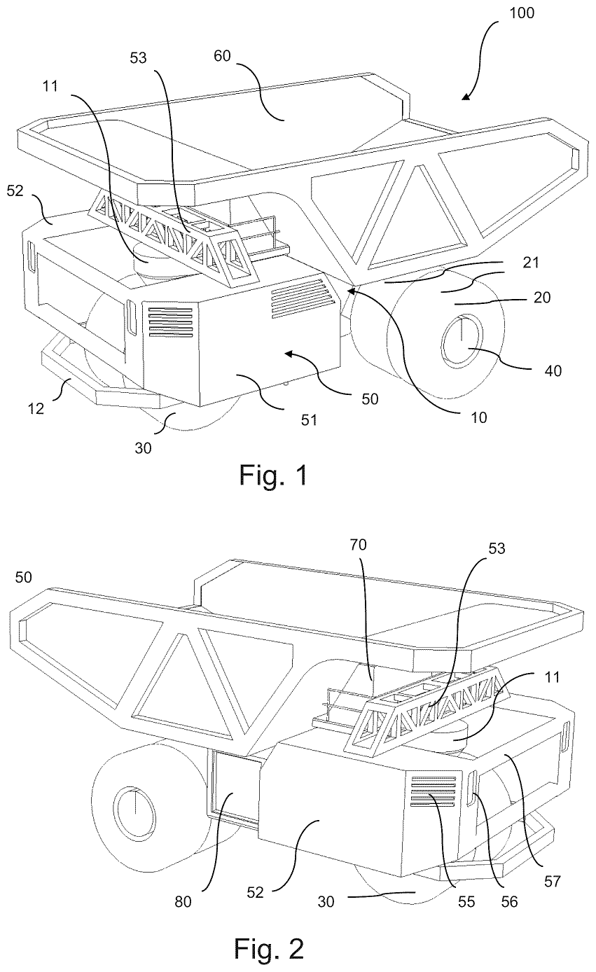

FIG. 1-6 show an embodiment of a vehicle embodying all aspects of the present disclosure. Therefore, the aspects of the present disclosure will be described with respect to the embodiment in combination. However, these aspects can also be implemented in the same way as described, but separately from each other. Further, FIG. 1-6 show a first embodiment of an exchangeable power unit according to the present disclosure.

We will first of all describe some of the general features of the vehicle of the present disclosure.

The vehicle 100 of the present disclosure comprises a frame 10, wheels 21, 31 and 32 arranged on the frame 10, at least one electrical traction motor 40 for driving the vehicle 100 and in particular at least one of the wheels 21, 31 and 32 of the vehicle 100, and an installation space 25 for an exchangeable power unit 50, the exchangeable power unit 50 comprising an energy source 58 and providing electrical energy to the at least one electrical traction motor 40 when installed in the installation space 25 on the vehicle. In operation, the exchangeable power unit 50 will therefore provide electrical energy to the at least one electrical traction motor 40 for the propulsion of the vehicle 100.

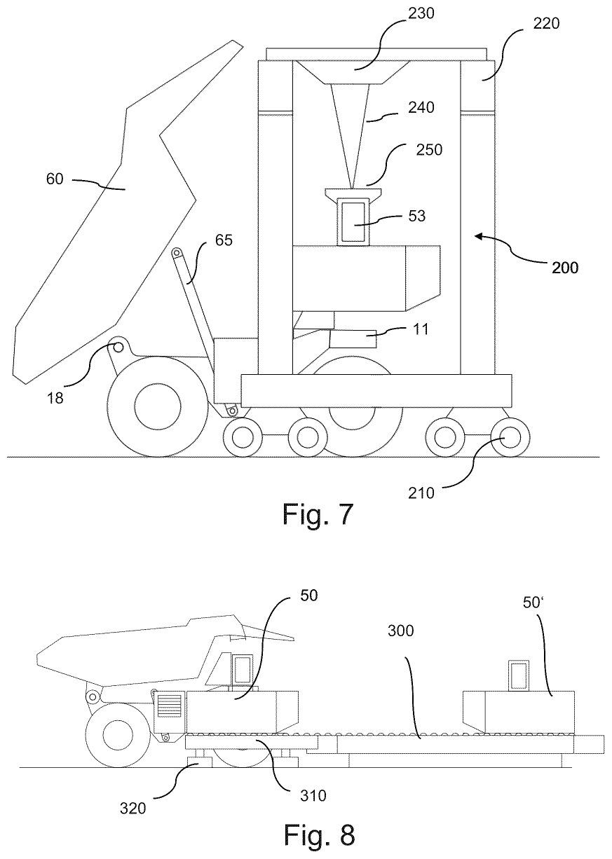

In the embodiment shown, the vehicle 100 is a dump truck. Therefore, it comprises a dump body 60 pivotably mounted on the frame 10. In particular, as shown in FIG. 7, the dump body 60 is pivotably attached to a dump body mount 18 of the frame 10 and pivotable about a horizontal axis. Further, a pivot actuator 65, such as one or more hydraulic cylinders, is provided for pivoting the dump body.

However, the present disclosure is not limited to dump trucks, but can be used generally for vehicles, in particular for ground vehicles such as trucks, earthmoving machines, or mobile cranes.

If the vehicle is a truck, such as a dump truck, the payload of the truck may be at least ten metric tons, optionally at least fifty metric tons, optionally at least one hundred metric tons.

Several independent aspects of the vehicle and the exchangeable power unit of the present disclosure will now be described in the following:

According to a first general aspect of the present disclosure, the frame 10 comprises a saddle mount 11 and the exchangeable power unit 50 comprises a first subunit 51 and a second subunit 52 connected by a cross member 53. In the embodiment, the first and the second subunit 51, 52 are arranged on lateral outer sides of the saddle mount 11 and the cross member 53 is supported by the saddle mount 11 when the exchangeable power unit 50 is mounted on the frame 10.

This configuration provides more space for the first and second subunits. Further, it allows easier access to the power unit for exchanging the power unit. It is protected independently from each other both for the vehicle and the exchangeable power unit.

Regarding vehicle, the frame comprises the saddle mount 11 and the installation space 25 comprises a first sub-space 26 for receiving the first sub-unit 51 of the power unit and a second sub-space 27 for receiving the second sub-unit 52 of the power unit, the first and the second sub-space 26, 27 being interconnected by a connection space 28. The first and the second sub-space 26, 27 are arranged on lateral outer sides of the saddle mount 11 and the connection space 28 extends from the first sub-space 26 over the saddle mount 11 to the second sub-space 27 and is configured to receive the cross member 53 of the exchangeable power unit connecting the first sub-unit 51 and the second sub-unit 52 such that the cross member 53 is supported by the saddle mount 11 when the exchangeable power unit is mounted on the frame 10.

Regarding the exchangeable power unit, the exchangeable power unit 50 comprises a first sub-unit 51 and a second sub-unit 52 connected by a cross member 53 and configured to power the at least one electrical traction motor 40 when installed on the vehicle.

In an embodiment, the first and the second sub-space 26, 27 and/or the first sub-unit 51 and a second sub-unit 52 are arranged in a longitudinal direction to overlap with a position of the saddle mount 11. In an embodiment, in a vertical direction, the first and the second sub-space 26, 27 and/or the first sub-unit 51 and the second sub-unit 52 extend at least partly below the vertical position of the saddle mount. In an embodiment, in a lateral direction, the first and the second sub-space 26, 27 and/or the first sub-unit 51 and the second sub-unit 52 extend at least partly and optionally completely on an outer side of the saddle mount.

In an embodiment, the saddle mount 11 and an installation space 25 for the exchangeable power unit 50 are fully accessible from a horizontal and/or vertical direction. In particular, the saddle mount 11 and the installation space 25 may be freely accessible from a front or a rear side of the vehicle.

In an embodiment, the installation space 25 is open to a front side or rear side and/or to lateral outer sides of the vehicle, such that the exchangeable power unit 50 forms, when installed in the installation space 25, an external structure of the vehicle. Therefore, the size of the exchangeable power unit 50 is not limited by the structure of the vehicle. Further, the exchange is simplified due to better accessibility.

In an embodiment, the vehicle 100 comprises an axle 30 on which at least one of the wheels 31, 32 is mounted, wherein the first and the second sub-space 26, 27 are arranged on lateral outer sides of the axle 30 such that the first and the second subunit 51 and 52 of the power unit are arranged on lateral outer sides of the axle 30 when the exchangeable power unit 50 is mounted on the frame 10. In particular, the first and the second sub-space and/or subunit are arranged on opposite lateral outer sides of the wheel or wheels mounted on the axle 30. By this configuration, the size of the first and the second sub-space and/or subunit is not limited by the axle and the wheels towards an outside of the vehicle.

In an embodiment, the saddle mount 11 is provided above a mounting structure 15 of the axle 30. Thereby, the saddle mount is supported by the axle.

In an embodiment, at least one of the saddle mount and the cross member is provided with a mechanical quick coupling connection element for establishing a releasable mechanical connection between the saddle mount and the cross member. Such a quick coupling connection element 58 is schematically shown in FIG. 6.

The quick coupling connection element may for example provide a form-fit connection that secures the cross member and the power unit on the saddle mount at least with respect to movements in a horizontal direction. Additionally or in a combination, the quick coupling connection element may secure the power unit on the saddle mount with respect to tilting movements and/or vertically. For example, the mechanical quick coupling connection may comprise screws, bolts and/or hydraulic or electric coupling mechanisms.

In an embodiment, the quick coupling connection element is configured such that the mechanical coupling can be released in less than five minutes, and that the coupling can be established within less than five minutes.

In an embodiment, the saddle mount and the cross member are provided with electrical quick coupling connection elements for establishing a releasable electrical connection between the exchangeable power unit and an electrical control unit of the vehicle. In particular, the electrical quick coupling connection elements may connect the batteries 58 of the power unit with an electrical grid of the vehicle.

In an embodiment, the saddle mount and the cross member may be provided with a hydraulic quick coupling connection for connecting a cooling circuit of the power unit with a cooling circuit of the vehicle. Alternatively, the power unit may be provided with a closed hydraulic circuit for the cooling of the power unit that is not coupled to the vehicle.

In an embodiment, the vehicle 100 and the exchangeable power unit 50 are configured such that a used and in particular de-charged exchangeable power unit can be exchanged with a newly conditioned and in particular charged exchangeable power unit in less than ten minutes, optionally in less than five minutes.

In the embodiment, the cross member 53 of the exchangeable power unit 50 is configured as a truss. In particular, the truss is a frame structure formed by a plurality of cross beams extending laterally with respect to the vehicle, which are interconnected by connection members. Therefore, it provides a stable and lightweight structure for carrying the power units connected to the lateral ends of the truss. In the embodiment, the lateral ends of the truss are connected to the upper side of the subunits 51 and 52, which are therefore provided in a hanging configuration on the cross member 53.

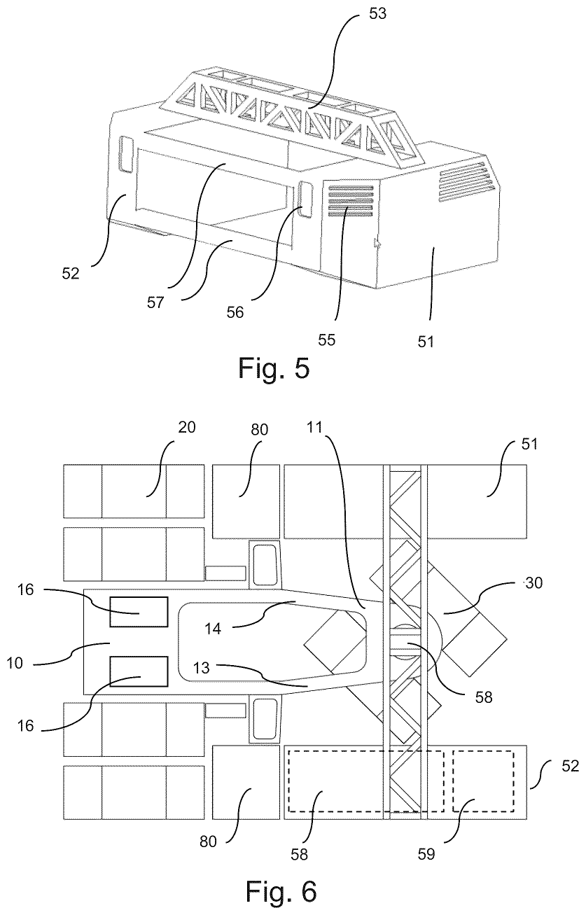

As can be seen in FIG. 5, in the embodiment, the first subunit 51 and the second subunit 52 of the power unit are further connected by at least a second cross member 57, the second cross member 57 forming a front or a rear structure of the vehicle. For this purpose, the first sub-space 26 and the second sub-space 27 of the installation space are interconnected by a second connection space 29 configured for receiving the second cross member 57, the second connection space 29 being open towards the front or rear side of the vehicle. The first and the second connection space may or may not be separated by structures of the vehicle. In the embodiment, the first and the second connection spaces together form a continuous connection space arranged above and in front of the front axle 30.

In the embodiment, two second cross members 57 are provided, connecting the front ends of the subunits 51 and 52 on an upper and a lower side.

In a second general aspect, which is independent from the first general aspect, the vehicle 100 comprises an axle 30 on which at least one of the wheels 31, 32 is mounted, and the exchangeable power unit 50 comprises a first subunit 51 and a second subunit 52 arranged on opposite lateral outer sides of the axle 30 when the exchangeable power unit 50 is mounted on the frame 10. Thereby, the first and the second subunits are not restricted in size by the axle 30 at least on their outer sides, therefore allowing more freedom in the design of the subunits and providing more installation space for the subunits.

For the vehicle according to the second aspect, which is protected independently from the power unit, this means that the installation space 25 comprises a first sub-space 26 and a second sub-space 27 arranged on lateral outer sides of the axle 30, the first sub-space 26 and a second sub-space 27 being configured for receiving the first sub-unit 51 and a second sub-unit 52 of the exchangeable power unit, respectively.

In the second general aspect, the first subunit and the second subunit may be separately mounted on the frame of the vehicle. In particular, they may not be mechanically interconnected by a cross member, but separately mounted on a first and a second power unit mount of the frame.

In an alternative embodiment, the first subunit and the second subunit may be mechanically connected by a cross member. However, the cross member may not necessarily be supported on a saddle mount, but only used for the transport of the power unit.

In a further alternative variant, the first and the second aspect of the present disclosure are provided in combination, such as shown in the embodiment, i.e. the first subunit and the second subunit are connected by a cross member that is supported on a saddle mount and arranged on opposite outer sides of an axle of the vehicle.

Optional aspects of a vehicle according to the first general aspect, according to the second general aspect, and according to a combination of the two aspects, as well as optional aspects of the power units of the present disclosure, are described in the following.

In an embodiment, the first and the second sub-space 26, 27 and/or the first sub-unit 51 and a second sub-unit 52 are arranged in a longitudinal direction to overlap with a position of the axle 30. In an embodiment, in a vertical direction, the first and the second sub-space 26, 27 and/or the first sub-unit 51 and the second sub-unit 52 extend to at least partly overlap with a vertical extension of the wheel and/or wheels of the axle 30. In an embodiment, in a lateral direction, the first and the second sub-space 26, 27 and/or the first sub-unit 51 and the second sub-unit 52 extend at least partly and optionally completely on an outer side of the axle 30.

In an embodiment, the axle 30 and/or the saddle mount 11 is provided at a center of the frame with respect to the lateral extension of the frame.

Therefore, the axle 30 and/or the saddle mount 11 centrally supports the frame on the rear or front side of the frame. This provides more space on the lateral outer sides of the axle 30 and/or the saddle mount 11 to provide the sub-spaces receiving the subunits of the power unit.

In an embodiment, the sub-spaces and/or subunits of the power unit may be arranged symmetrically with respect to a vertical center plane of the vehicle extending in a front-rear direction.

In an embodiment, the outer lateral sides of the subunits of the power unit define an outer lateral side surface of the vehicle. Further, outer lateral sides of the sub-spaces may be open to the environment.

In an embodiment, the axle 30 is a front axle, the vehicle further comprising rear wheels arranged on the frame 10 wherein the rear wheels are arranged on a left and right outer lateral sides of the frame 10 behind the first and second sub-space 26, 27 of the installation space 25.

In an embodiment, in a lateral direction, the first and the second sub-space 26, 27 and/or the first sub-unit 51 and the second sub-unit 52 at least partly overlap with wheels of the vehicle, in particular the rear wheels. In particular, in a lateral direction, the inner side of the first and the second sub-space 26, 27 and/or of the first sub-unit 51 and the second sub-unit 52 may recessed an outer side of the wheels, in particular of the rear wheels.

In an embodiment, in a lateral direction, the first and the second sub-space 26, 27 and/or the first sub-unit 51 and the second sub-unit 52 may extend from a position of an outer lateral side of the frame towards a position of an outer lateral side of the wheels, in particular of the rear wheels.

In an embodiment, the vehicle has a three-axle configuration, with a central axis 30 provided on a first longitudinal side, such as the front side, and two axes provided at a second, opposite longitudinal side, such as the rear side, with the three axes provided in a triangular configuration with respect to each other.

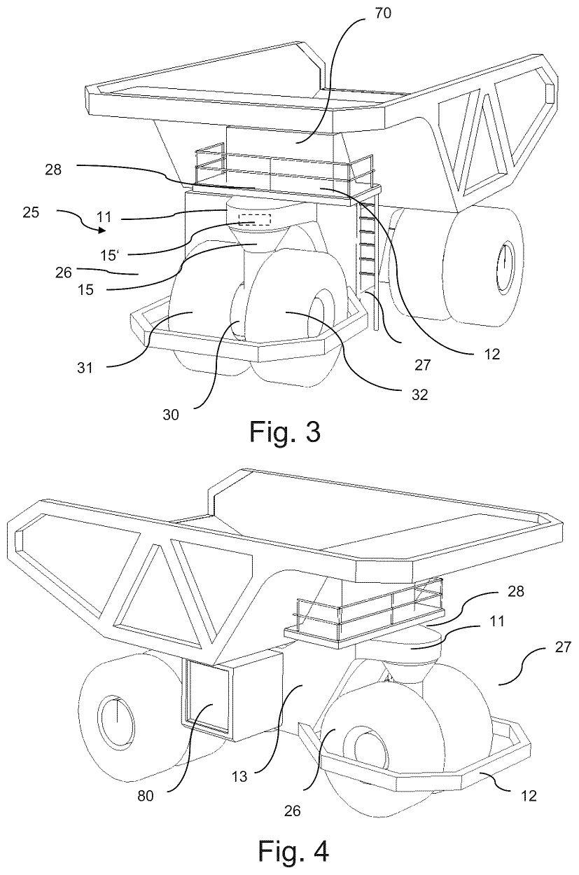

In an embodiment, the vehicle 100 comprises a steering axle 15 arranged on the frame 10 and a steering actuator 15′ as schematically shown in FIG. 3, wherein the axle 30 is mounted on the steering axle 15 and configured to be turned by the steering actuator 15′ for steering the vehicle 100.

In the embodiment, the steering axle 15 is arranged at a center of the frame 10 with respect to a lateral extension of the frame.

Each of the axles may be provided with one or more wheels. In the embodiment, the axle 30 is provided with a first wheel 31 and a second wheel 32 mounted on the axle 30 on opposite sides of the steering axle 15. In an alternative configuration, a single wheel may be provided symmetrically with respect to the steering axle 15.

In an embodiment, the steering axle 15 and the steering actuator 15′ are configured to turn the axle 30 by at least 180°, in particular by at least +/−90° with respect to a zero position where the vehicle drives along a straight path.

By this configuration, the turning radius of the vehicle is very small, such that the vehicle requires less space for maneuvering.

In an embodiment, the steering actuator may be provided by a rotary motor, such as an electric or hydraulic motor. Therefore, the steering system can be configured without hydraulic cylinders.

In the embodiment, the steering axle is arranged vertically and allows turning of the axle 30 around a vertical axis.

In the embodiment, the steering axle 15 comprises a column element extending from the axle 30 in a vertical direction to a steering mount to which the steering axle is rotatably attached. The axle 30 extends horizontally. In the embodiment, on both sides of the steering axle 15, wheels 31 and 32 are rotatably arranged on the axle 30.

In the embodiment, the wheels 31 and 32 of axle 30 are caster wheels, i.e. they are not actively driven. This simplifies the construction of the axle 30. In an alternative embodiment, the wheels 31 and 32 may be driven by traction motors.

In the embodiment, the vehicle comprises an enclosure element 12 arranged on the frame 10 and surrounding the axle 30 such that the at least one of the wheels 31, 32 arranged on the axle 30 is positioned and configured to turn with the axle 30 within a space surrounded by the enclosure element 12. The enclosure element 12 therefore protects the axle 30 and the wheels 31, 32 arranged on the axle 30. Further, it may have the functionality of a bumper structure.

In an embodiment, the enclosure element 12 and/or the subunits 51 and 52 of the exchangeable power unit 50 comprise coupling elements for releasably coupling them to each other. In particular, such coupling elements may provide additional mechanical stability to the vehicle when the exchangeable power unit is arranged on the vehicle, by mechanically securing the subunits to the enclosure element 12.

In the embodiment, the enclosure element 12 is connected to side beams 13, 14 of the frame. It is provided by beam elements enclosing the axle 30.

In the embodiment, the saddle mount 11 is arranged on the frame 10 above the steering axle 15. In particular, the saddle mount 11 may be a platform arranged on a first longitudinal end of the frame, with the steering axle mounted to a lower side of this platform. The steering actuator 15′ may be arranged within the saddle mount or the platform forming the saddle mount 11.

In the embodiment, the saddle mount 11 is provided as a platform connected to a first longitudinal end of side beams 13 and 14 of the frame structure. The saddle mount 11 is arranged vertically above the wheels 31 and 32 or the axle 30.

In particular, the saddle mount 11 is provided on a front end of the frame and/or a front end of the side beams 13 and 14 of the frame structure.

As described above, the exchangeable power unit 50 may comprise a cross member 53 connecting the first subunit 51 and the second subunit 52, the cross member 53 being supported on the saddle mount 11 when the exchangeable power unit 50 is mounted on the vehicle.

In the configuration shown, the saddle mount 11, the installation space 25 and/or the connection space 28 extending above the saddle mount 11 are freely accessible from a first longitudinal side of the vehicle, in particular from a front side of the vehicle. Further, at least in one configuration, such as when the dump body is pivoted in an upper pivot position, the saddle mount 11, the installation space 25 and/or the connection space 28 extending above the saddle mount 11 are also freely accessible in a vertical direction. In particular, no frame elements are arranged on a front side or an upper side of the saddle mount and/or the installation space 25 and/or the connection space 28.

In the embodiment, the axle 30 is a front axle and the vehicle further comprises rear wheels 21 arranged on the frame 10. In an embodiment, the rear wheels are arranged on a rear end of the side beams 13 and 14 of the frame structure.

In an embodiment, the vehicle may be configured for bi-directional travel. In this case, what is described as the front end side and the front axle within the present disclosure may, in operation, be provided on a rear side with respect to the direction of travel.

As shown in FIG. 6, the rear wheels 21 or the rear axles 20 may be arranged on the two lateral sides of the frame 10. In the embodiment, rear wheel mounts 16 supporting the rear wheels are fixedly connected to the frame 10, i.e. the wheels are arranged on the frame without a suspension. Thereby, the frame can be provided with a simplified and lightweight structure. Damping is, in this configuration, provided by the tires of the wheels.

The electrical traction motors 40 may be integrated in the rear wheels or rear axles, and be provided as a motor-gear-unit.

As shown in FIGS. 1 and 2, when the exchangeable power unit is mounted on the vehicle, it forms an outer surface of the vehicle on the lateral and/or a first longitudinal side, in particular on a front side of the vehicle.

In such a configuration, the installation space 25 for the exchangeable power unit 50 is not limited by frame elements or chassis elements of the vehicle on the lateral outer sides, or a first longitudinal side, such as a front or rear side, but freely accessible from these sides. Further, in the embodiment, the installation space 25 is not limited by frame elements or chassis elements from a vertical side.

In the embodiment, because the exchangeable power unit 50 forms a front or rear side of the vehicle, in an embodiment, it is provided with headlights 56. The headlights 56 may in particular be provided in each of the subunits 51 and 52.

The vehicle may be operated with any type of exchangeable power unit. It may in particular operate with different types of zero emission power units.

Possible technologies for the power unit are for example:
a battery electric power unit; therein, each sub-unit 51, 52 may comprise at least one battery unit;
a fuel cell power unit; therein, each sub-unit 51, 52 may comprise at least a fuel cell and/or a battery unit. Hydrogen tanks may be provided above and/or between the sub-units 51, 52.
a combustion engine power unit; therein, each sub-unit 51, 52 may comprise a combustion engine and a generator;
a hybrid power unit comprising a combustion engine driving a generator and a battery unit.

As shown in FIG. 6, in an embodiment where the exchangeable power unit is a battery electric power unit, each of the subunits 51, 52 comprises at least one battery module 58.

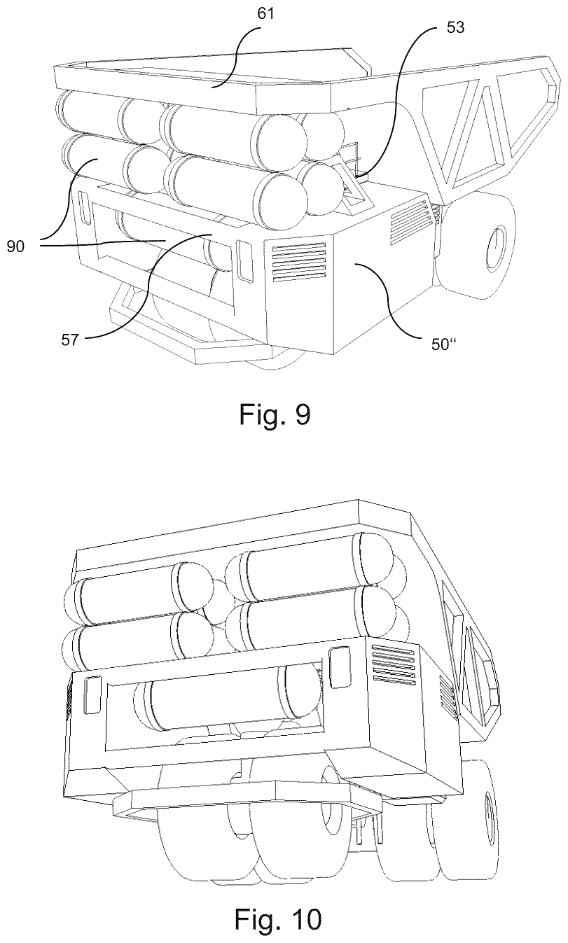

As shown in FIGS. 9 and 10, in an embodiment where the exchangeable power unit 50′″ is operated by hydrogen, such as in a fuel cell power unit and/or a hydrogen combustion engine, hydrogen tanks 90 may be provided in a space above the axle 30 and below the front end 61 of the dump body 60. For example, the hydrogen tanks 90 may be provided between the sub-units 51, 52 and/or at a level above the sub-units 51, 52 in front of the cross member 53 and/or above the cross member.

Further aspects of the exchangeable power unit, which are independent from the type of power source, are described in the following:

In an embodiment, the power unit may comprise an integrated cooling system 59.

In an embodiment, each of the subunits comprises a separate integrated cooling system. Alternatively, the two subunits may share a cooling system integrated into the power unit.

In the embodiment, the integrated cooling system 59 of the power unit is independent from the vehicle. In particular, a cooling circuit of the power unit may be separate from the vehicle, such that no hydraulic connection is required between the power unit and the vehicle.

In the embodiment, the power unit 51 is provided with radiators 55 of the integrated cooling system. Thereby, no radiators are required on the vehicle for cooling the batteries, but the radiators are integrated in the power unit. The radiators may be heat exchangers of the cooling system for releasing heat to the environment. They are in particular air-liquid heat exchangers and/or provided with one or more fans.

In the embodiment, radiators are integrated in one or each of the subunits 51, 52.

In an embodiment, the subunits 51 and 52 may be separate structural modules, which are connected by one or more cross members.

In an embodiment, the vehicle 100 further comprises a fixed power unit 80 providing power to the vehicle when the exchangeable power unit 50 is dismounted from the vehicle. The power and charge capacity provided by the fixed power unit 80 may be sufficient for propulsion of the vehicle.

For example, the fixed power unit may operate as a secondary power unit to power the vehicle during maintenance, such as when exchanging the wheels and/or tires, or during the exchange of the exchangeable power unit 50 in case that this exchange requires a movement of the vehicle.

In an embodiment, the fixed power unit 80 is recharged by the exchangeable power unit 50.

In the embodiment, the fixed power unit 80 is provided as two units arranged on the lateral outer sides of the frame between the rear wheels and the installation space 25 for the exchangeable power unit.

In an embodiment, the vehicle 100 is an autonomous vehicle. In the embodiment shown, it is therefore not provided with a cabin for a driver, as it is exclusively controlled autonomously or remotely when in operation.

As shown in FIG. 3, the battery electrical vehicle is still provided with a bridge 12, but no cabin is arranged on the bridge. However, a control cabinet 70 comprising a controller of the vehicle is provided on the bridge 12.

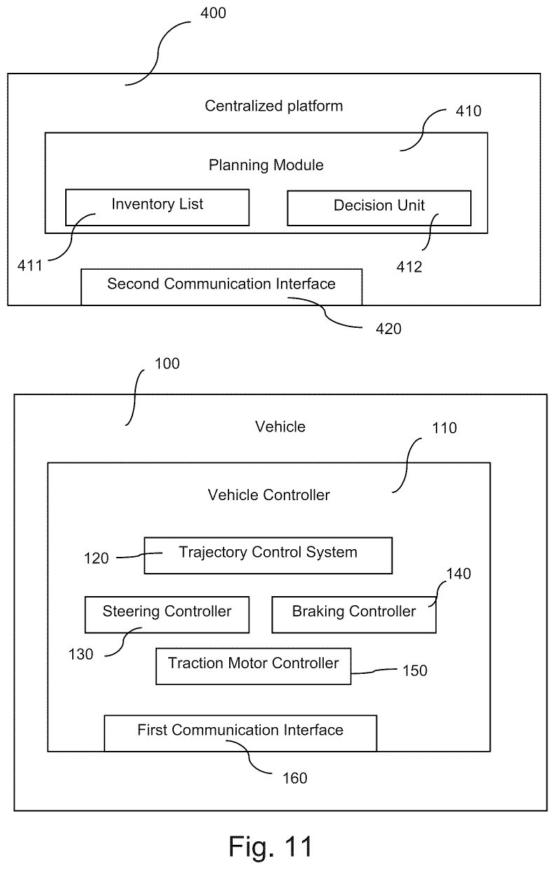

FIG. 11 shows a schematic diagram of the vehicle controller 110 of the vehicle.

In the embodiment, the vehicle controller 110 comprises a first communication interface 160 configured to wirelessly communicate with a centralized platform 400 for receiving a predetermined mission, and a trajectory control system 120 configured to autonomously control the autonomous vehicle 100 according to the predetermined mission received from the centralized platform. The predetermined mission may in particular comprise a starting point, an end point and/or a trajectory to be followed by the vehicle.

The trajectory control system 120 may in particular control a steering controller 130, a breaking controller 140 and a traction motor controller 150. The steering controller 130 may in particular control the steering actuator 15′, and the traction motor controller 150 may in particular control the traction motors 40.

The vehicle controller may further comprise or be in communication with sensors of the vehicle, such as vision sensors, LiDAR and/or radar sensors. Further, the vehicle controller 110 may be provided with a positioning system, such as a GPS system.

FIG. 11 further shows an embodiment of a system according to the present disclosure. The system is configured for operating a plurality of vehicles on a site, in particular on a mine site, in particular on an open mine site. The system comprises, in the embodiment, a plurality of vehicles according to the first and/or the second general aspect as defined above, or according to any of the optional aspects defined above. Further, the system comprises a centralized platform 400 comprising a planning module 410 for planning missions for the plurality of vehicles. Further, the centralized platform 400 may comprise a second communication interface 420 configured to wirelessly communicate with the first communication interface 160 of the vehicles for communicating the missions to the vehicles.

A further system according to the present disclosure is shown in FIGS. 7 and 8. The system is configured for operation of a plurality of vehicles on a site, in particular on a mine site, in particular on an open mine site. This system comprises a plurality of vehicles 100 according to the first and/or the second aspect as defined above, or any of the optional aspects as defined above. The system further comprises at least one power unit exchange station 200, 300 for exchanging the exchangeable power unit 50.

The power unity exchange station 200, 300 may comprises at least one actuator 230, 320 for horizontally and/or vertically removing the exchangeable power unit from the vehicle.

Once the exchangeable battery unit 50 of a vehicle is no longer sufficiently charged or has to undergo maintenance, the vehicle may drive to the power unit exchange station, and the exchangeable power unit 50 mounted on the vehicle may be replaced with a new exchangeable power unit. Therefore, no charging and/or maintenance of the exchangeable power unit is necessary while it is arranged on the vehicle.

Due to the configuration of the vehicle, exchange of the exchangeable power unit is simplified, as the installation space for the power unit is easily accessible.

In the embodiment shown in FIG. 7, power unit exchange station 200 is configured as a portal crane, which can be moved above the exchangeable power unit 50 while the power unit is still arranged on the truck. For this purpose, it is provided with a movement mechanism 210, such as wheels. Alternatively, the vehicle may be driven below the portal structure 220 of the power unit exchange station and the portal structure may be stationary. In the configuration shown in FIG. 7, the dump body 60 is pivoted in an upper dump position for exchange of the exchangeable power unit, such that the front end 61 of the dump body is no longer arranged above the exchangeable power unit, such that the exchangeable power unit can be removed vertically.

In the embodiment of FIG. 7, the power unit exchange station 200 comprises a gripper or hook 250 for connecting to the cross member 53 of the exchangeable power unit 50, the gripper or hook 250 being arranged on a crane cable 240 for raising the power unit from the vehicle. The power unit exchange station can, in the same way, also lower a charged and/or reconditioned power unit into its mounting position on the vehicle.

In the embodiment shown in FIG. 8, the power unit exchange station is configured for removing and/or inserting the exchangeable power unit horizontally, and in particular from a front side of the vehicle 100.

In particular, it is provided with a turntable 300 on which the exchangeable power unit arranged on the vehicle is moved in a horizontal direction, and by turning the turntable 300, a charged exchangeable power unit 50′ can be provided in front of the vehicle.

In addition to the turntable 300, the power unit exchange station comprises a mounting station 310, configured as two platforms for supporting the subunits 51 and 52 of the exchangeable power unit from below. The mounting station 310 is provided with one or more actuators 320 for raising and/or lowering the exchangeable power unit in its mounting position on the vehicle. Once the exchangeable power unit has been raised out of its mounting position, it can be removed horizontally from the mounting station 310 onto the turntable 300, just as the charged and/or reconditioned exchangeable power unit 50′ can be moved from the turntable 300 onto the mounting station 310 for being lowered into the mounting position.

In an embodiment of the present disclosure, the system comprises a plurality of exchangeable power units of a first type and a second type, the first type and the second type differing in at least one out of electrical storage capacity, power unit type and weight. Due to the configuration of the system, such differently-sized or configured exchangeable power units can be easily provided. The embodiment is particularly useful with battery electric power units differing in at least one out of electrical storage capacity and weight. It may however also be used for electric power units having different power unit types such as battery electric power units and power units comprising an internal combustion engine.

In an embodiment, the first type of power unit or second type of power unit is chosen for operation of the vehicle depending on the missions assigned to the vehicle.

In particular, as already discussed with respect to the system shown in FIG. 11, the system may comprise a centralized platform 400 comprising a planning module 410 for planning missions for the plurality of vehicles and assigning such missions to the vehicles.

In an embodiment, the planning module 410 comprises an inventory list 411 of the plurality of exchangeable power units of a first type and a second type, and a decision unit 412 configured to select the first type or the second type of exchangeable power unit to be used for a specific vehicle depending on the missions assigned to the vehicle.

In case that the vehicles are operated manually, the centralized platform may communicate the type of exchangeable power unit to be used for a specific vehicle to the operator of the vehicle and/or the operator of an exchange station.

In an embodiment, however, the vehicle and/or the exchange station is operated autonomously and/or semi-autonomously.

In an embodiment, the centralized platform 400 comprises a second communication interface 420 configured to communicate the missions to the plurality of vehicles and/or to communicate the decision of the decision unit to the battery exchange station.

As already indicated above, each of the vehicles may comprise a first communication interface configured to wirelessly communicate with the second communication interface of the centralized platform for receiving a predetermined mission and a trajectory control system 120 configured to autonomously control the vehicle according to the predetermined mission.

Further, in the embodiment, the at least one power unit exchange station is configured to autonomously exchange the exchangeable power units depending on an output of the decision unit 412. In particular, the power unit exchange station may be in communication with the centralized platform 400, and may receive from the decision unit 412 a decision whether to use a first type or a second type of exchangeable battery unit for a specific vehicle, and may comprise a controller configured to control the actuator or actuators of the power unit exchange station to select a corresponding exchangeable battery unit for providing the vehicle with the type of power unit chosen by the decision unit 412.

The centralized platform 400, the vehicle controller 110 and/or a controller of the power unit exchange station may each be provided with at least one microprocessor and at least one computer program stored in a memory, the computer program, when running on the microprocessor, controlling the centralized platform, the vehicle and/or the battery exchange station to perform the steps and provide the functionality described above and in the following.

In a further independent aspect, the present disclosure comprises a method for operating a plurality of vehicles on a site, in particular on a mine site. The method comprises operating a plurality of vehicles to perform missions, each of the vehicles being a vehicle according to the first or second general aspect described above, or any of the optional aspects described above. The method further comprises, when a charge state of a first exchangeable power unit used for operating one of the vehicles is below a threshold, exchanging the first exchangeable power unit with a fully loaded second exchangeable power unit and statically loading the first exchangeable power unit while it is dismounted from the vehicle.

Therefore, no charging of the exchangeable power unit is required while the exchangeable power unit is arranged on the vehicle. Instead, a depleted exchangeable power unit is simply exchanged for a fully loaded exchangeable power unit.

According to an embodiment, the second exchangeable power unit is selected from a first type or a second type of exchangeable power units, the first type and the second type differing in at least one out of electrical storage capacity and weight, and the method further comprises selecting the first type or the second type of exchangeable power unit for the second exchangeable power unit depending on missions assigned to the vehicle.

Therefore, the type of exchangeable power unit and in particular its electrical storage capacity can be selected depending on the missions assigned to the vehicle, such that in case that the missions do not require the full power of a first type, a second type having a lower storage capacity can be used. Because the lower storage capacity will result in less weight of the second type, the weight of the vehicle is reduced, allowing the battery electrical vehicle to load higher payloads, and/or save energy during operation.

1. A vehicle, comprising
a frame,
wheels arranged on the frame,
at least one electrical traction motor for driving the vehicle,
an installation space for an exchangeable power unit, the vehicle being configured such that the exchangeable power unit provides, when installed in the installation space, electrical energy to the at least one electrical traction motor,
wherein the frame comprises a saddle mount and the installation space comprises a first sub-space for receiving a first sub-unit of the power unit and a second sub-space for receiving a second sub-unit of the power unit, the first and the second sub-space being interconnected by a connection space,
wherein the first and the second sub-space are arranged on lateral outer sides of the saddle mount and the connection space extends from the first sub-space over the saddle mount to the second sub-space and is configured to receive a cross member of the exchangeable power unit connecting the first sub-unit and the second sub-unit such that the cross member is supported by the saddle mount when the exchangeable power unit is mounted on the frame.

2. The vehicle of claim 1, comprising an axle on which at least one of the wheels is mounted, wherein the first and the second sub-space are arranged on lateral outer sides of the axle.

3. The vehicle of claim 2, wherein the saddle mount is provided above a mounting structure of the axle.

4. The vehicle of claim 1, wherein the saddle mount is provided with a mechanical quick coupling connection element configured for establishing a releasable mechanical connection between the saddle mount and the cross member and/or wherein the saddle mount is provided with electrical quick coupling connection elements for establishing a releasable electrical connection between an electrical control unit of the vehicle and the exchangeable power unit.

5. The vehicle of claim 1, wherein the installation space is open to a front side or rear side and/or to lateral outer sides of the vehicle, such that the exchangeable power unit forms, when installed in the installation space, an external structure of the vehicle.

6. The vehicle of claim 1, wherein the first sub-space and the second sub-space of the installation space are interconnected by a second connection space configured for receiving a second cross member interconnecting the first sub-unit and the second sub-unit, the second connection space being open towards the front or rear side of the vehicle such that the second cross member forms a front or a rear structure of the vehicle when the exchangeable power unit is installed on the vehicle.

7. A vehicle, comprising
a frame,
wheels arranged on the frame,
at least one electrical traction motor for driving the vehicle,
an axle on which at least one of the wheels is mounted,
an installation space for an exchangeable power unit, the vehicle being configured such that the exchangeable power unit provides, when installed in the installation space, electrical energy to the at least one electrical traction motor,
wherein the installation space comprises a first sub-space and a second sub-space arranged on lateral outer sides of the axle, the first sub-space and a second sub-space being configured for receiving a first sub-unit and a second sub-unit of the exchangeable power unit, respectively.

8. The vehicle of claim 7, comprising a steering axle arranged on the frame and a steering actuator, wherein the axle is mounted on the steering axle and configured to be turned by the steering actuator for steering the vehicle.

9. The vehicle of claim 8, wherein the steering axle is arranged at a center of the frame with respect to the lateral extension of the frame.

10. The vehicle of claim 8, wherein the steering axle and the steering actuator are configured to turn the axle by at least 180°,
and/or wherein a first and a second wheel are mounted on the axle on opposite sides of the steering axle,
and/or wherein the vehicle comprises an enclosure element arranged on the frame and surrounding the axle such that the at least one of the wheels arranged on the axle is positioned and configured to turn with the axle within a space surrounded by the enclosure element, wherein the enclosure element comprises coupling elements for releasably coupling to the sub-units of the exchangeable power unit.

11. The vehicle of claim 9, wherein a saddle mount is arranged on the frame above the steering axle, and wherein the installation space comprises a connection space connecting the first and the second sub-space, wherein the connection space extends from the first sub-space over the saddle mount to the second sub-space and is configured to receive a cross member of the exchangeable power unit connecting the first sub-unit and the second sub-unit such that the cross member is supported by the saddle mount when the exchangeable power unit is mounted on the frame.

12. The vehicle of claim 7, wherein the axle is a front axle, the vehicle further comprising rear wheels arranged on the frame, wherein the rear wheels are arranged on a left and right outer lateral sides of the frame behind the first and second sub-space of the installation space 13. The vehicle of claim 1, wherein the vehicle further comprises a fixed power unit providing power to the vehicle when the exchangeable power unit is dismounted from the vehicle, the fixed power unit being configured to be recharged by the exchangeable power unit.

14. The vehicle of claim 1, wherein the vehicle is an autonomous vehicle comprising:
a first communication interface configured to wirelessly communicate with a centralized platform for receiving a predetermined mission, and
a trajectory control system configured to autonomously control the autonomous vehicle according to the predetermined mission.

15. The vehicle of claim 1, wherein the vehicle is a dump truck comprising a dump body pivotably mounted on the frame.

16. A vehicle according to claim 1, comprising an exchangeable power unit, the exchangeable power unit comprising a first sub-unit and a second sub-unit connected by a cross member.

17. An exchangeable power unit for a vehicle according to claim 1, the exchangeable power unit comprising a first sub-unit and a second sub-unit connected by a cross member, the cross member configured to support the weight of the first sub-unit and the second sub-unit.

18. The exchangeable power unit of claim 17, wherein the cross member is configured as a truss and/or comprises mechanical and/or electrical coupling elements for coupling to a saddle mount of the vehicle.

19. The exchangeable power unit of claim 17, comprising at least one out of headlights and an integrated cooling system that is independent from the vehicle.

20. The exchangeable power unit of claim 17, wherein the exchangeable power unit is one out of: a battery electric power unit, each sub-unit comprising at least one battery unit; a fuel cell power unit; a combustion engine power unit, each sub-unit comprising a combustion engine; and a hybrid power unit comprising a combustion engine and a battery unit.

21. A system for operating a plurality of vehicles on a site, the system comprising:
a plurality of vehicles according to claim 1, and
at least one power unit exchange station for exchanging the exchangeable power unit, the power unit exchange station comprising at least one actuator for horizontally and/or vertically removing the exchangeable power unit from the vehicle.

22. The system according to claim 21, comprising
a plurality of exchangeable power units of a first type and a second type, the first type and the second type differing in at least one out of electrical storage capacity, power unit type and weight, and
a centralized platform comprising a planning module for planning missions for the plurality of vehicles,
the planning module comprising an inventory list of the plurality of exchangeable power units of a first type and a second type, and a decision unit configured to select the first type or the second type of exchangeable power unit to be used for a vehicle depending on the missions assigned to the vehicle.

23. The system according to claim 21, wherein the centralized platform comprises a second communication interface configured to communicate the missions to the plurality of vehicles, each of the vehicles comprising a first communication interface configured to wirelessly communicate with the second communication interface of the centralized platform for receiving a predetermined mission and a trajectory control system configured to autonomously control the vehicle according to the predetermined mission, wherein the at least one battery exchange station is configured to autonomously exchange the exchangeable power units depending on an output of the decision unit.
